(19) United States
(12) Patent Application Publication
(10) Pub. No.: US 2010/0215055 A1
(43) Pub. Date: Aug. 26, 2010

(54) METHOD AND APPARATUS FOR USING MULTIPLE PROTOCOLS ON A COMMUNICATION LINK

(76) Inventor: Stephen D. Glaser, San Francisco, CA (US)

Correspondence Address: ZAGORIN O'BRIEN GRAHAM LLP (151), 7600B N. Capital of Texas Hwy, Ste. 350, Austin, TX, 78731, US

(21) Appl. No.: 12/392,735

(22) Filed: Feb. 25, 2009

(51) Int. Cl. H04J 3/22

(52) U.S. Cl. 370/469

(57) ABSTRACT

Multiple protocols are utilized on a single communication link. Information received over the communication link includes a protocol identification field specifying if the communication link is to operate under a first protocol or a different protocol. The second device interprets information transferred on the communication link according to one of the first protocol and the other protocols according to the protocol identification field.

### CROSS-REFERENCE TO RELATED APPLICATION(S)

### BACKGROUND

1. Field of the Invention

This invention relates to a communication link and to utilizing multiple protocols on the communication link.

2. Description of the Related Art

High speed communication links are common in computer systems to transport data between processor cores and between processor cores and such devices as graphical processing units and/or various input/output devices. Exemplary communication links include the HyperTransport™ (HT) and PCI Express™ (PCIe), which provide unidirectional point-to-point communication links between devices in the computer system. The protocols implemented by the various communication links are unique to the particular communication link.

### SUMMARY

In order to provide a more flexible system, multiple protocols are allowed to exist on a single communication link. In an embodiment, a method is provided for utilizing multiple protocols on a communication link that couples a first and a second device. The method includes receiving information at the second device transmitted from the first device over the communication link. The information includes a protocol identification field specifying if the communication link is to operate under a first protocol or another protocol. The second device interprets the information according to one of the first protocol and the other protocol according to the protocol identification field.

In another embodiment, a device is provided that includes a communication interface for communicating with a communication link. The communications interface is responsive to a protocol identification field received over the communications interface to receive information over the communication link using one of a first protocol and one or more additional protocols according to the protocol identification field. In an embodiment, the device includes a first and a second receive queue, respectively utilized for the first and a second protocol, the second protocol being one of the one or more additional protocols. In an embodiment, the protocol identification field is included as part of a length field of the first protocol. In an embodiment, the device is responsive to the length field being less than or equal to a predetermined amount to receive information over the communication link according to the first protocol and if the length field is greater than the predetermined amount to receive information over the communication link according to one of the one or more additional protocols.

### BRIEF DESCRIPTION OF THE DRAWINGS

The present invention may be better understood, and its numerous objects, features, and advantages made apparent to those skilled in the art by referencing the accompanying drawings.

FIG. 1 illustrates exemplary communication links coupling a first device and a second device that may be utilized in embodiments of the invention.

FIG. 2 illustrates additional details of the devices shown in FIG. 1 for supporting tunneling on a communication link.

FIG. 3 illustrates a PCIe TLP layout for a 2.5 or 5 GT/s communication link.

FIG. 4 illustrates a tunneled packet layout according to an embodiment of the invention.

FIG. 5 shows a PCIe TLP layout for 8 GT/sec.

FIG. 6 shows a tunneled packet layout according to an embodiment of the invention.

FIG. 7 illustrates an embodiment of the invention in which tunneling capability on a communication link allows a device to participate in a coherency protocol.

FIG. 8 illustrates a portion of a PCIe Data Link Layer Packet (DLLP) utilized to identify a tunneled DLLP according to an embodiment of the invention.

The use of the same reference symbols in different drawings indicates similar or identical items.

### DESCRIPTION OF THE PREFERRED EMBODIMENT(S)

Referring to FIG. 1, an exemplary communication link 100 is shown that includes point-to-point unidirectional links 101 and 103 coupling a first device 105 and a second device 107. Assume that communication link 101 is coupling the devices in the downstream direction. Communication link 103 couples device 105 and device 107 for transmissions in the upstream direction.

According to an embodiment of the invention, device 107 is capable of interpreting communication received over link 101 under multiple protocols using protocol identification information received from the device 105. Thus, link 101 can operate according to a first protocol such as PCIe, and while in a tunneled mode the link can operate according to a different protocol, e.g., HT protocol or other protocol different from PCIe. That provides greater flexibility for the system.

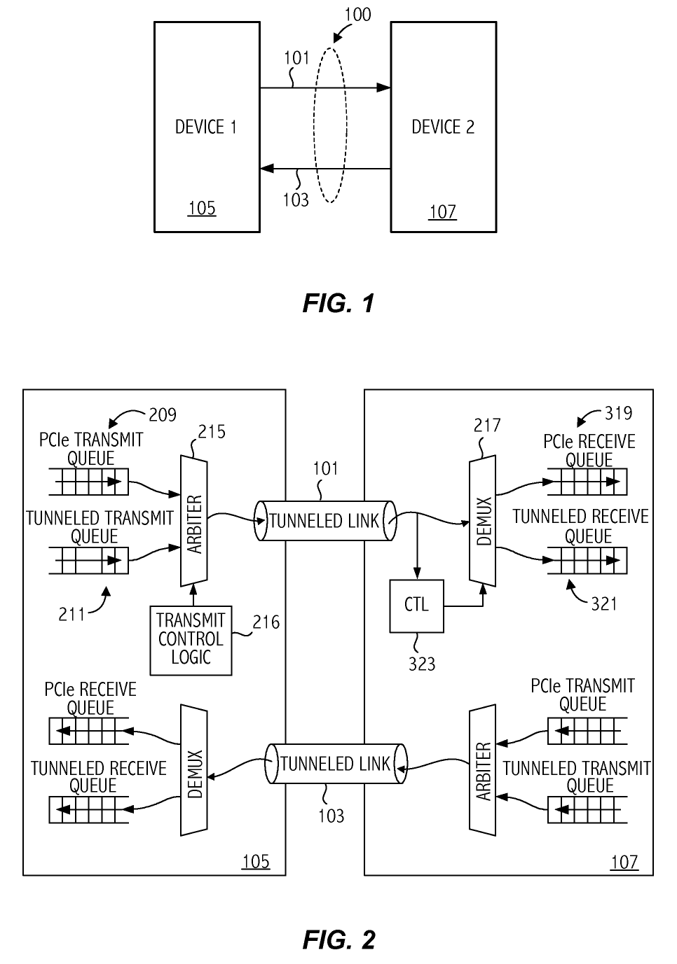

Utilization of different protocols typically requires such additional supports as independent buffering of data sent and received using the different protocols, independent flow control resources, and independent sequence numbers. That is to ensure that transactions occurring with a first protocol do not interfere with transactions using a second protocol. Thus, ordering and other aspects of transactions can remain independent even though multiple protocols can be utilized. That requires some additional hardware resources. Referring to FIG. 2, shown are additional details of the devices illustrated in FIG. 1. In FIG. 2, the devices 105 and 107 support tunneling (utilizing multiple communication protocols), both in the downstream direction of communication link 101 and in the upstream direction on communication link 103. Note that the choice of upstream or downstream in FIG. 2 is arbitrary, although in most computer system communication links, the direction towards the processor is upstream. In embodiments of the invention, if a protocol is supported in the upstream direction by the two devices, it will also be supported in the downstream direction.

As shown in FIG. 2, in order to support two protocols, the devices 105 and 107 have two separate transmit queues for transactions in the downstream direction. Transmit queue 209 supports the PCIe protocol. Transmit queue 211 supports the “tunneled” protocol. That is, transmit queue 211 supports a second protocol, e.g., HT, on communication link 101. While two transmit queues are shown, additional transmit queues may be utilized to support additional protocols used on the link 101. An arbiter 215 determines which transmit queue to supply to the link based on control inputs from transmit control logic 216 that determines the appropriate protocol based on, e.g., the particular operations being performed on device 105. The control logic also provides in a conventional manner the appropriate formatting for the information transmitted. On the receive side, a demultiplexer 217 receives the link information stream and supplies the received information to the appropriate receive queue 219 and 221 according to the protocol currently operating for a transaction on the link 101. As explained in more detail herein, protocol identification bits in the packet identify the protocol that should be used. Control logic 323 controls the demultiplexer with appropriate control information based on the protocol identification bits. The control logic 323 watches for the protocol identification bits, which are typically only a few bits into the packet as described further herein. A similar structure applies to the transmit and receive queues associated with communication link 103.

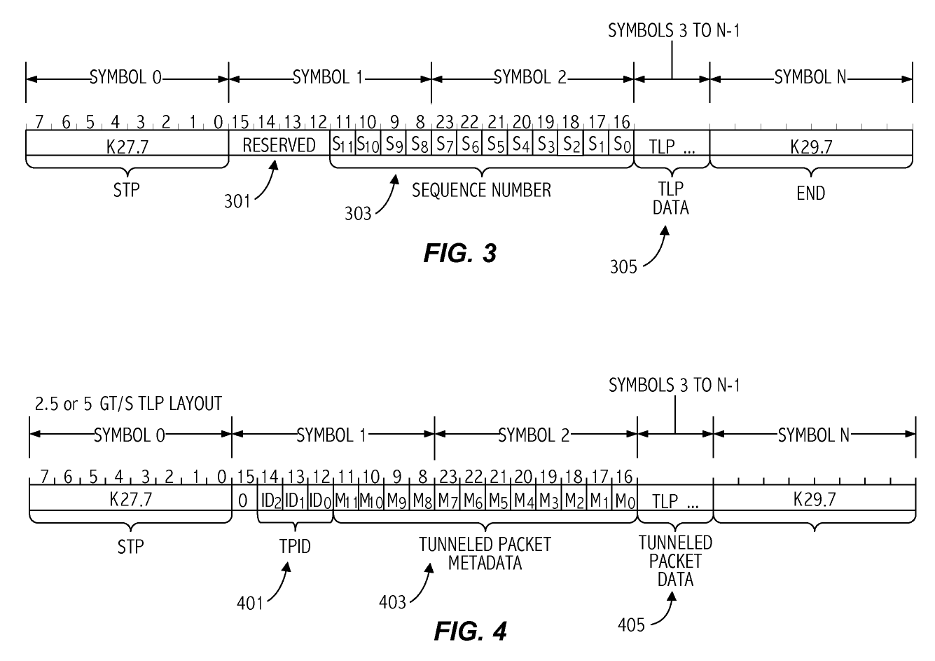

In order to be able to use a different protocol on a communication link, it is desirable to minimize impact to the default protocol, particularly so as not to burden the existing framing protocol with additional bits. The framing protocol identifies the boundaries of information being transferred in accordance with the protocol. For example, a start and end indication may be utilized in the protocol to indicate the beginning and end of the information transfer. Accordingly, one embodiment uses reserved bits of an existing framing protocol to indicate when to use a different protocol. Referring to FIG. 3, shown is the layout for a PCIe transaction layer packet (TLP) for implementations that support 2.5 GT/s or 5 GT/s transfers. Some or all of the reserved bits 301 are used to indicate whether to use a protocol different than PCIe, i.e., when tunneling is used on the link. In an embodiment, a protocol ID field is incorporated into the reserved bit field. A predetermined value, such as 0, in the protocol ID field indicates the default or a first protocol (e.g., PCIe) and a non-zero value indicates another protocol. Depending on the size of the protocol ID field, multiple different protocols can be identified. For example, if the protocol ID field is three bits, seven additional protocols can be specified in addition to the default protocol identified by a zero value in the protocol ID.

FIG. 4 illustrates how the packet of FIG. 3 is modified in layout if the protocol ID is non-zero. Assume that a non-zero protocol ID is contained in 401, which is part of the reserved field 301 of the 2.5 or 5 GT/sec TLP shown in FIG. 3. Given a non-zero protocol ID field 401, the receiving device knows to interpret the received TLP as shown in FIG. 4. The sequence numbers 303 in the 2.5 or 5 GT/sec TLP become tunneled packet metadata 403 in the tunneled packet. Also, the PCI3 TLP data becomes tunneled packet data. Note that in the embodiment Start and End K characters are not changed. Both PCIe TLPs and tunneled packets use the same START and END characters to indicate the beginning and end of the packet.

Assume the reserved bits 301 are used for the Protocol ID (PID) field. In order to prevent a device that does not support multiple protocols from treating the received information transfer as a default protocol transfer, in one embodiment, if any of the four reserved bits 301 are non-zero, the link cyclic redundancy check (LCRC) is computed by the sending device using a 1's complement of the 4 bit reserved field. A device that supports the multiple protocols, when it sees a non-zero reserved bits, will also compute its LCRC using a 1's complement of the reserved bits, thus matching the CRC of the transmitting device. However, a receiving device that does not support multiple protocols, will not use the 1's complement and therefore will generate a different LCRC than the one received from the transmitting device, thus forcing an error. In that way the CRC check fails when an existing component that does not support multiple protocols accidentally gets a transfer that used a different protocol. A link CRC failure is better than the unpredictable result of the receiving and processing a transfer assuming it is a first protocol when it was transmitted according to a second protocol.

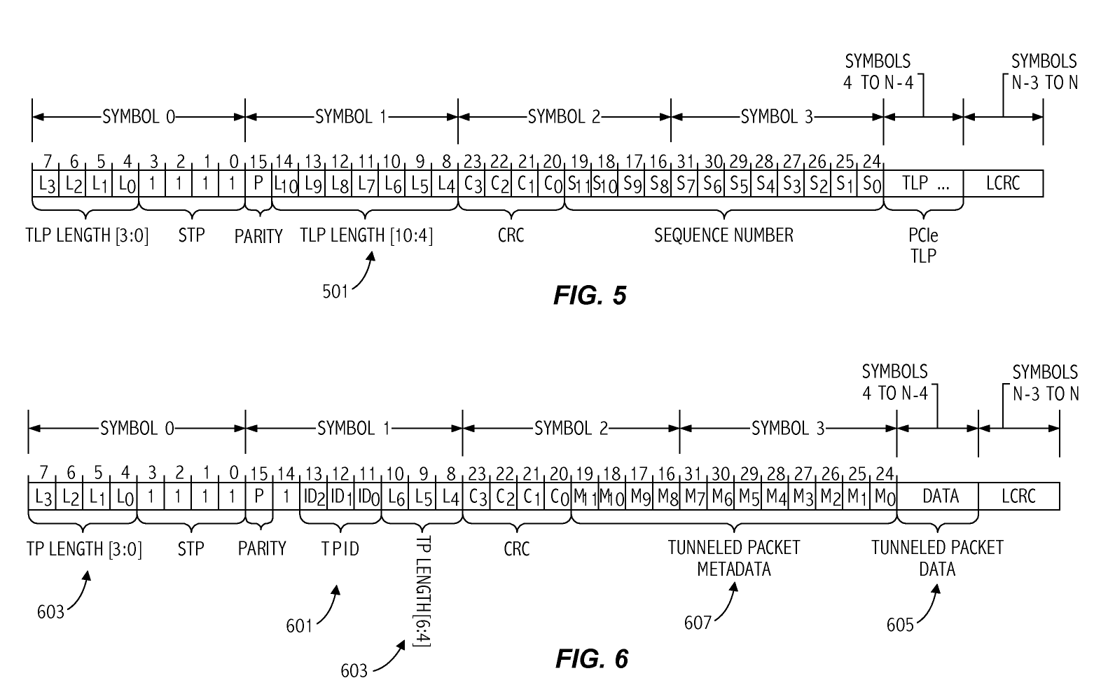

Referring to FIG. 5, in another embodiment, rather than utilizing reserved bits of the default protocol, the TLP length field 501 is utilized to identify when to use a different protocol without burdening the protocol with additional bits. The length field is used to identify the number of double words transferred for PCIe links with data rates of 8 GT/s or higher. However, the length field may be significantly larger than the largest expected transfer. For example, the 11 bit length field 501 shown in FIG. 5 can specify between 2 . . . 2047 double words (DWs) to be transferred. The current maximum value for PCIe TLPs transfers is approximately 1039 double words. The 1039 double word value includes one double word for framing (Length, STP, Parity, CRC Sequence #), four double words for the Link Local TLP Prefix, four double words for the End-End TLP Prefix; a four double word TLP Header; and 1024 TLP Data double words, one double word for ECRC, and one double word for LCRC. If the maximum value for a TLP transfer is rounded up to 1151 double words, that means that values greater than 1151 should not exist in the length field. That allows length values>1151 to be used to identify other protocols. Thus, for PCIe transfers, TLP Length[10:7]<1001b. That is, TLP Length[10:7] bits are either 1000b or 0xxxb in order for the length field to be less than 1151.

According to an embodiment, if the TLP length field is 0 . . . 1151, then the TLP is PCIe and protocol ID is 0. If the TLP length field>1151, then TLP Length[9:7] contains the Protocol ID (PID) and the packet is a tunneled packet. Note that a packet refers to a data transfer that includes at least header information and a data payload. Referring to FIG. 6, illustrated is a tunneled packet layout according to an embodiment of the invention derived when the packet in FIG. 5 is used for default transfers. Note that for the tunneled packet illustrated in FIG. 6, the PID>000b and TLP Length[10]=1 in order for the length to be greater than 1151. The actual length of the tunneled data transfer may be specified in TLP Length[6:0]. The length may be specified in double words. If double words are specified using TLP Length[6:0] the size of the tunneled packet is limited to 125 double words. Note that assumes, as in PCIe, the TLP Length field includes the two DWs allocated for framing and LCRC.

Rather than limiting the data transfer size of a tunneled packet to 125 double words, in an embodiment, one bit is used to identify a different base transfer size instead of double words. Thus, for example, if Length[6]=0, then Length[5:0] specifies the tunneled packet size in double words. However, if Length[6]=1, then Length[5:0] specifies the tunneled packet size as a multiple of a base amount, e.g., a base amount of 64 double word units, thereby allowing for a 16K byte tunneled packet size.

Note that the assignment of protocol identifications need not be symmetric for the uplink and downlink in an embodiment. That is, in such an embodiment, the Tx and Rx on a device could use different values for the same protocol identification or the same values. Thus, referring back to FIG. 1, a different protocol number may be used to specify the same protocol on links 101 and 103. In addition, the protocol numbers used could be dynamic. That is, a protocol number may be changed by software, or another mechanism. Alternatively, the protocols that may be used on a link may be set up during configuration.

Referring again to FIG. 6, the TPID field is shown at 601. The tunneled packet (TP) length field 603 (TP Length[6:4] and TP Length[3:0]) are used for the length of the tunneled packet data 605. In addition, 12 bits of tunneled packet metadata 607 replace the 12 bit sequence field in the PCIe TLP layout. Thus, the transmitting device replaces the appropriate fields as shown in FIG. 6 with tunneled packet information including the TPID, the TP length, TP metadata and TP data. In that way, a protocol separate from the default PCIe protocol can operate on the communication link.

Referring back to FIG. 2, in PCIe, the receive queue typically receives all of the packet including the TLP Header and TLP Payload (TLP Data 305). The receive queue does not typically include the sequence number, start and end K characters and might not include the LCRC. LCRC is checked on the way into the receive queue and buffer space is immediately freed on a bad LCRC (otherwise the queue could overflow). For the embodiment described in relation to FIG. 6, in PCIe, the TLP Length field is used to locate LCRC and subsequent packets on the link. It need not be part of the queue for PCIe, but for the tunneling world, the TPID is preserved (typically implicitly based on which receive queue got the packet).

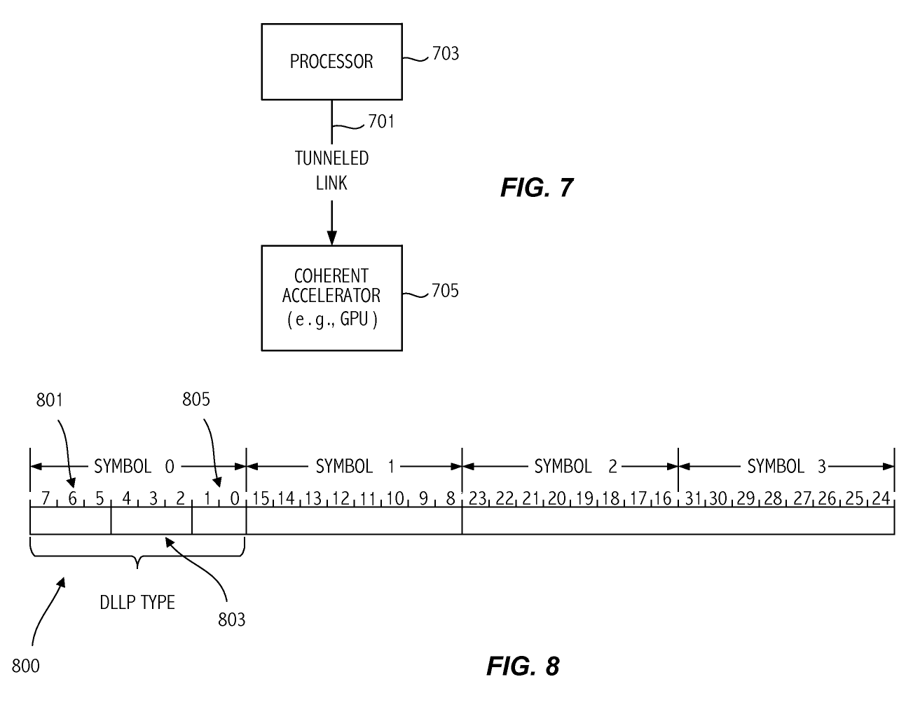

Referring to FIG. 7, according to an embodiment of the invention, a tunneled link 701 couples processor 703 and an Accelerator, e.g., a graphics processing unit 705. The tunneled link 701 is capable of operating using a protocol that is specified in a packet received from the processor. While the tunneled link 701 can operate according to a first protocol such as PCIe, while in a tunneled mode, the link can operate according to a different protocol, e.g., an HT protocol or other protocol different from PCIe. That allows the GPU 705 to participate in the coherency protocol of the processor 701. Thus, e.g., the memory that is accessible only by the GPU can remain coherent with respect to the processor memory. At other times, link 701 operates in a non-tunneled mode using the default protocol on the link.

Referring to FIG. 8 illustrated is a portion of a PCIe Data Link Layer Packet (DLLP). In addition to TLPs, one or more embodiments of the invention may utilize DLLPs for tunneled transactions. DLLPs are used in PCIe protocol for flow control, power management, and other link control messages. The DLLP type field 800, which is an eight bit field with relatively few types defined can be used to identify new opcodes associated with the tunneled protocol. Three bits, e.g., bits 801, identify that the DLLP is an opcode associated with a tunneled protocol. Three bits, e.g., bits 803, indicate that the protocol ID. Finally, two bits 805 indicate the type of DLLP within the particular protocol identified by the protocol ID. The value of the three bits 801 to specify that the DLLP is an opcode associated with a tunneled protocol is based on the defined values for the type field. That is, the three bits are chosen so as to not be in any defined values in PCIe for the type field.

In order to enable tunneling on a particular link, one approach enables tunneling using software, e.g., during link configuration. In another embodiment tunneling is enabled through a dynamic protocol using DLLPs. Note that in PCIe, receivers ignore DLLPs they do not understand, so as long as the opcode is reserved against future use, DLLPs can be used to negotiate new features. Of course, systems can use both approaches or a different one to enable tunneling on a communication link.

Thus, various embodiments have been described to allow multiple protocols to exist on a communication link including having independent protocol streams, independent buffering and flow control resources, and independent sequence numbering. The description of the invention set forth herein is illustrative, and is not intended to limit the scope of the invention as set forth in the following claims. For example, while the PCIe protocol was described as an exemplary default protocol, the approach described herein, can be used for other protocols in order to provide capability for allowing multiple protocols to exist on a particular communication link. Variations and modifications of the embodiments disclosed herein may be made based on the description set forth herein, without departing from the scope of the invention as set forth in the following claims.

What is claimed is:

1. A method for utilizing multiple protocols on a communication link that couples a first and a second device, the method comprising:
receiving information at the second device from the first device over the communication link, the information including a protocol identification field specifying if the communication link is to operate under a first protocol or one or more other protocols; and
interpreting the information received using one of the first protocol and the other protocols according to the protocol field.

2. The method as recited in claim 1 further comprising using independent buffers, flow control and sequence numbering for the first and other protocols.

3. The method as recited in claim 1 wherein the protocol identification field is included in a reserved field specified by the first protocol.

4. The method as recited in claim 3 further comprising computing a cyclic redundancy check using a 1's complement of the protocol field if any bits in the reserved field are non-zero.

5. The method as recited in claim 1 wherein the protocol field is included as part of a length field specified by the first protocol.

6. The method as recited in claim 1 further comprising determining the protocol to be the first protocol if a length according to the length field is less than or equal to a predetermined amount and if the length field is greater than the predetermined amount determining the protocol to be one of the other one or more protocols.

7. The method as recited in claim 6 wherein if the length field is greater than the predetermined amount, using one or more bits of the length field to determine which of the other one or more protocols should be used.

8. The method as recited in claim 7 wherein if the length field is greater than the predetermined amount, other bits of the length field specify the amount of data to be transmitted.

9. The method as recited in claim 8 wherein one bit of the other bits specifies that the remaining ones of the other bits indicates an amount of data to be transferred as a multiple of a base amount.

10. The method as recited in claim 1 further comprising communicating over the communication link according to the first protocol during a first time period and communicating over the link using one of the other protocols during a second time period.

11. The method as recited in claim 1 further comprising participating in a coherency protocol with the first device during the second time period.

12. The method as recited in claim 1 wherein the communication link is unidirectional from first to the second device.

13. The method as recited in claim 1 wherein protocol identification field is included as part of a type field identifying a type of link control packet.

14. A device comprising:
a communication interface for communicating with a communication link; and
the communications interface responsive to a protocol identification field received over the communications interface to receive information over the communication link using one of a first protocol and one or more additional protocols according to the protocol identification field.

15. The device as recited in claim 14 further comprising at least a first and second transmit queue, respectively utilized for the first and a second protocol, the second protocol being one of the one or more additional protocols.

16. The device as recited in claim 14 further comprising a first and second receive queue, respectively utilized for the first and and a second protocol, the second protocol being one of the one or more additional protocols.

17. The device as recited in claim 14 wherein the protocol identification field is included in a reserved field of the first protocol.

18. The device as recited in claim 17 wherein the device is operable to compute a cyclic redundancy check value using a 1's complement of the protocol identification field if any of the protocol identification field bits are non-zero.

19. The device as recited in claim 14 wherein the protocol identification field is included as part of a length field of the first protocol.

20. The device as recited in claim 19, wherein the device is responsive to the length field being less than or equal to a predetermined amount to receive information over the communication link according to the first protocol and if the length field is greater than the predetermined amount to receive information over the communication link according to the one or more additional protocols.

21. The device as recited in claim 20 wherein if the length field is greater than the predetermined amount, the device is operable to determine which of the other one or more protocols should be used.

22. The device as recited in claim 21 wherein if the length field is greater than the predetermined amount, the device is responsive to other bits of the length field to determine a packet size.

23. The device as recited in claim 22 wherein one bit of the other bits specifies that the remaining ones of the other bits indicates a packet size as a multiple of a base amount.
